(19) United States
(12) Patent Application Publication
(10) Pub. No.: US 2010/0088935 A1
(43) Pub. Date: Apr. 15, 2010

(54) Street sign extrusion

(76) Inventor: Michael R. Rykaczewski, Butler, PA (US)

Correspondence Address: KAREN TANG-WAI SODINI, 216 horseshoe drive, MARS, PA, 16046, US

(21) Appl. No.: 12/462,016

(22) Filed: Jul. 28, 2009

Related U.S. Application Data
(60) Provisional application No. 61/196,171, filed on Oct. 15, 2008.

(51) Int. Cl. G09F 7/00

(52) U.S. Cl. 40/612

(57) ABSTRACT

A street sign, made typically at least in part using an extrusion process, having a flat elongated section where the name of a street can be inscribed or otherwise indicated, and a length of thickened section along the top edge or the bottom edge of the flat elongated section, and including a channel or slot along at least a portion of the length of the thickened section.

### CROSS REFERENCE TO RELATED APPLICATION

Reference is made to and priority claimed from U.S. provisional application Ser. No. 61/196,171, filed Oct. 15, 2008.

### TECHNICAL FIELD

The present invention relates in general to street signs and more particularly to street identification sign assemblies of the type mounted on vertical posts.

### BACKGROUND OF THE INVENTION

The prior art provides various extruded, cast, or stamped forms for street signs of the type mounted on vertical posts. One such form is an extrusion having a thickened section along the entire length of the top and a thickened section along the entire length of the bottom of an otherwise thin flat section. The thickened sections provide some structural rigidity, especially useful in preventing vandalism.

Street signs generally show only the name of the street, and often because of local, state, or federal regulation, do not show any additional information. Communities often do wish to communicate additional information. For example, a school route could be indicated, or an historic trail, or a route to a hospital. Therefore additional information is sometimes provided by hanging a sign bearing the additional information from the street sign. For example, a second sign, bearing information other than the name of a street, is hung from a street sign using two chains attached to two holes in the street sign and two holes in the hung sign. Such sign assemblies are objectionable to some people on the grounds that the hung sign sways when there is wind or even just a breeze from a passing car.

What is needed is a way to provide additional information using a structure that is more an integral part of a street sign, without violating any local, state or federal regulations.

### DISCLOSURE OF INVENTION

Accordingly, the invention provides a street sign that meets all federal, state and local regulations, but unlike the prior art, includes a slot/channel in a thickened section along at least a portion of the top or the bottom of the sign, into which additional (decorative or informative) signage may be inserted.

### BRIEF DESCRIPTION OF THE DRAWINGS

The features and advantages of the invention will become apparent from a consideration of the subsequent detailed description presented in connection with accompanying drawings, in which:

FIG. 1 is a perspective drawing showing a cutaway view of the street sign.

FIG. 2 is perspective drawing showing a top view of the street sign.

FIG. 3 is an enlarged perspective drawing of the channel of the street side.

### DETAILED DESCRIPTION

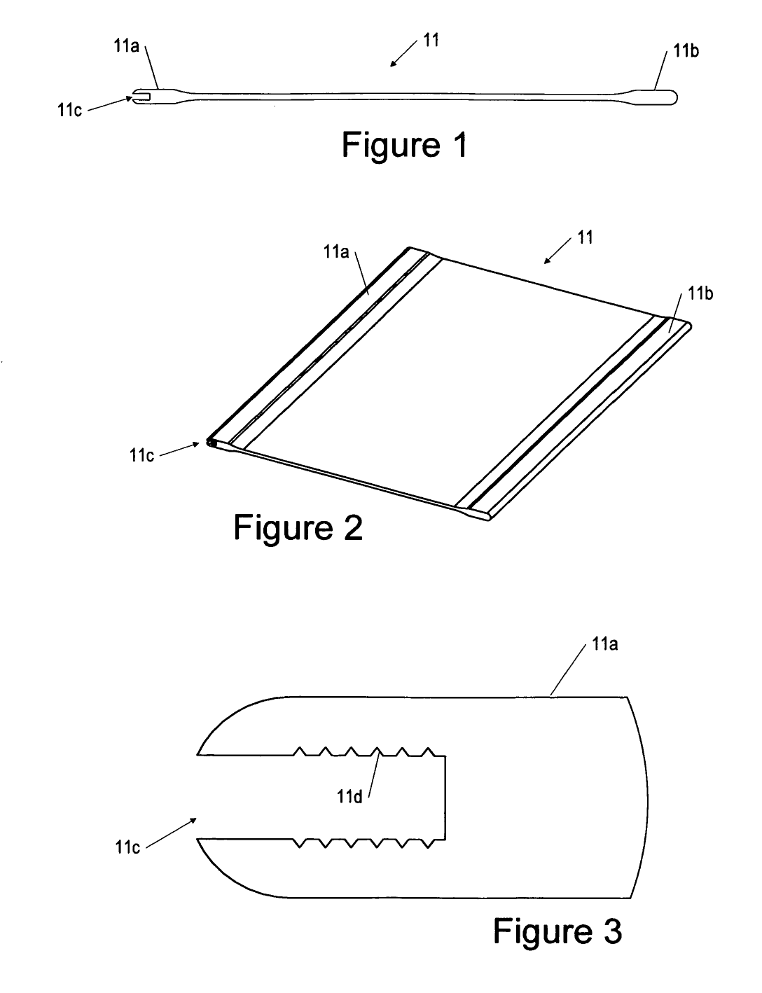

Referring to FIGS. 1-3, in a typical embodiment of the invention, a street sign 11 is provided as an extrusion of a material, typically but limited to a metal such as aluminum, and includes a thickened section 11a along the top of the extrusion, and a similar thickened section 11b along the bottom of the extrusion, and a channel/slot 11c along the length of the top thickened section, of a thickness suitable for holding a secondary sign other than a street sign, having typically uniform thickness, used for decorative purposes or for conveying information other than the name of the street. When the secondary sign is inserted in the channel/slot provided according to the invention, the thickened section serves to provide additional strength to both the street sign and to the secondary sign. The secondary sign is thus, i.e. by virtue of the channel provided by the invention, made more integral with the street sign than a secondary sign hung from a street sign using two chains, according to the prior art.

In a typical embodiment, the secondary sign is secured in the channel/slot with an adhesive. Also in a typical embodiment, and as shown in FIG. 1, within the channel/slot are design features in the form of special grooves 11d formed along the length of the channel or slot, that provide small reservoirs for the adhesive to accumulate, and once signage is inserted into the slot and the adhesive dries, the groove feature provides a negative cavity to create much greater strength for the securing of secondary signage.

The invention also encompasses embodiments in which the channel/slot 11c is provided only over a portion of the length of a thickened section as opposed to along the entire length, but in such embodiments the channel/slot must be provided by other than an extrusion process although an extrusion process may be used to provide the base sign, i.e. the sign less the channel/slot.

The invention should be understood to encompass a slot or channel along the top of the top thickened section or instead (or in addition) along the bottom of the bottom thickened section. In case of the latter, the secondary sign is disposed below the street sign to which it is made an integral member by virtue of the channel or slot provided by the invention.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. An apparatus for use as a street sign, comprising:
a substantially flat elongated section for inscribing or otherwise indicating the name of a street, and having a top edge and a bottom edge above and below where the name of the street is provided, respectively; and
a length of thickened section along the top edge or the bottom edge;
wherein the thickened section is provided so as to include a channel or slot along at least a portion of the length of the thickened section.

2. An apparatus as in claim 1, wherein the channel or slot has a feature of a shape and size sufficient for holding an adhesive.
